(19) United States
(12) Patent Application Publication
(10) Pub. No.: US 2009/0256539 A1
(43) Pub. Date: Oct. 15, 2009

(54) Circuits and Methods for Sensing Current

(75) Inventor: Sridhar V Kotikalapoodi, Santa Clara, CA (US)

Correspondence Address: FOUNTAINHEAD LAW GROUP, PC, 900 LAFAYETTE STREET, SUITE 200, SANTA CLARA, CA, 95050, US

(73) Assignee: Summit Microelectronics, Inc., Sunnyvale, CA (US)

(21) Appl. No.: 12/246,500

(22) Filed: Oct. 6, 2008

Related U.S. Application Data
(60) Provisional application No. 60/998,024, filed on Oct. 5, 2007.

(51) Int. Cl. G05F 1/10

(52) U.S. Cl. 323/282

(57) ABSTRACT

Embodiments of the present invention include techniques for sensing current. In one embodiment, a switch in a switching regulator is coupled to a power supply. Input current from the supply is translated into an output current of the switching regulator. A signal corresponding to the output current is generated. The signal is selectively turned off with the input switch is open. Accordingly, the signal tracks the input current into the regulator. The signal may be used to determine the input current. In one embodiment, the signal is a voltage signal generated by a current corresponding to the output current provided into a resistor.

### CROSS REFERENCE TO RELATED APPLICATIONS

This invention relates to and claims priority from U.S. Provisional Patent Application No. 60/998,024 filed Oct. 5, 2007 naming Sridhar V. Kotikalapoodi as inventors, the contents of which is hereby incorporated herein by reference in its entirety.

### BACKGROUND

The present invention relates to sensing current in electronic devices, and in particular, to systems and methods for sensing current in switching regulators.

Electronic devices require power in the form of voltages and currents to operate. Switching regulators are often employed to provide such power. Switching regulators receive voltage and current from a power source, and provide power at an output terminal by coupling the voltages and currents through switches and inductors. The switching are turned on and off in a controlled manner. Inductors are used to store energy while the switches are off and maintain a relatively constant current flow.

It is often desirable to determine the current flowing at the input and output of a switching regulator. Typically, such currents are determined by coupling the input and output currents of the regulator through a resistor. Current flowing through the resistor is transformed into a voltage. The voltage is linearly related to the input or output current.

One of the benefits of using a switching regulator is such circuits are highly efficient. However, using resistors to sense the input and output currents is inefficient because the resistors dissipate energy in the form of heat. Thus, there is a need for improved circuits and methods for sensing currents, especially in switching systems such as regulators.

### SUMMARY

Embodiments of the present invention include techniques for sensing current. In one embodiment, a switch in a switching regulator is coupled to a power supply. Input current from the supply is translated into an output current of the switching regulator. A signal corresponding to the output current is generated. The signal is selectively turned off with the input switch is open. Accordingly, the signal tracks the input current into the regulator. The signal may be used to determine the input current. In one embodiment, the signal is a voltage signal generated by a current corresponding to the output current provided into a resistor.

In one embodiment, the present invention includes a switching regulator comprising an input switch for receiving an input voltage and input current from a voltage source, the input switch receiving a switching signal, wherein the switching signal turns the input switch on and off, an inductor having a first terminal coupled to the input switch, the inductor generating an output current, and a converter, the converter sensing the output current and generating a signal, wherein the signal corresponds to the output current, wherein the signal is activated and deactivated so that the signal is active when the input current flows through the input switch and the signal is deactivated when the input current does not flow through the switch.

In another embodiment, the present invention includes a method comprising receiving an input current in a switching regulator. The switching regulator may include an input switch, and the input switch includes a first terminal coupled to a power supply voltage source to receive the input current. The input switch includes a second terminal coupled to a first node, and wherein the input switch is turned on (i.e., closed) and off (i.e., open) by a controller.

In one embodiment, a first switching signal from a controller is generated. The first switching signal may be coupled to the input switch to turn the input switch on and off.

In one embodiment, a second switch is coupled between the first node and a reference voltage. The reference voltage may be ground, for example. A second switching signal may be generated from the controller for turning the second switch on and off. The second switching signal may complimentary to (i.e., the inverse of) the first switching signal, for example. The second switching signal may be coupled to the second switch to turning the second switch on when the first switch is off and turn the second switch off when the first switch is on.

Switching regulators typically include inductors. In one embodiment, a terminal of an inductor is coupled to a terminal of the input switch. In one embodiment, an inductor is coupled between the first node and a second node. An output current is generated in the inductor in response to switching the switches.

In one embodiment, the output current is coupled through a sense resistor.

In one embodiment, the output current may be converted into a voltage.

In one embodiment, a voltage corresponding to (e.g., generated from) the output current is converted into a signal (e.g., a voltage or current signal) corresponding to the output current. The signal may represent the same waveform shape as current flowing through the input switch, for example.

In one embodiment, a signal corresponding to the output current is deactivated when the input switch is off and activated when the input switch is on, and in accordance therewith, a signal corresponding to the input current may be generated. In one embodiment, the signal is a voltage or current signal. In some embodiments, the signal (e.g., a voltage or current corresponding to the input current) is low pass filtered.

In one embodiment, a current or voltage signal may be coupled to a controller and used to control switching in the switching regulator. For example, in one embodiment, the voltage or current signal may be used to control the switching signal used to turn the input switch on and off. The signal may be used to control the switching signal so that the input current does not exceed a threshold value, for example.

The following detailed description and accompanying drawings provide a better understanding of the nature and advantages of the present invention.

### BRIEF DESCRIPTION OF THE DRAWINGS

FIG. 1 illustrates an electronic circuit according to one embodiment of the present invention.

FIG. 2 illustrates the waveforms for the embodiment of FIG. 1.

### DISCLOSURE

Described herein are techniques for current sensing. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include obvious modifications and equivalents of the features and concepts described herein.

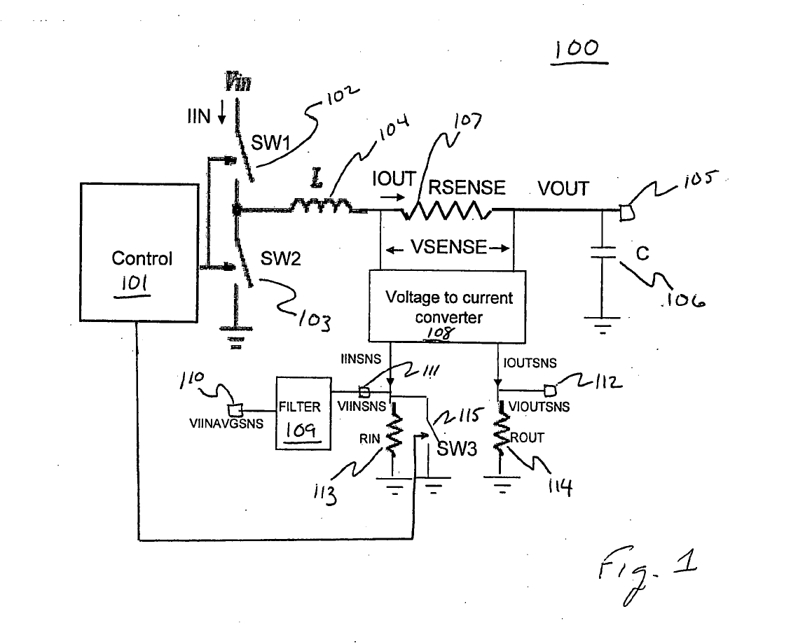

FIG. 1 illustrates an electronic circuit 100 for performing current sensing according to one embodiment of the present invention. Electronic circuit 100 includes switch control 101, a first switch 102, a second switch 103, an inductor 104, a capacitor 106, a sense resistor 107, a voltage to current converter 108, a filter 109, a resistor 113 (“RIN”), a resistor 114 (“ROUT”), and a third switch 115. This embodiment utilizes a step down switching regulator with current sensing, but other converters/regulators such as a non-inverting buck-boost may also be utilized, for example. Non-synchronous converters where the second switch 103 is replaced with a diode may also be utilized, for example. The output current IOUT is sensed with a sense resistor (RSENSE) 107 in this embodiment. Alternate methods may be implemented to sense the output current. In this embodiment, the output current IOUT generates a voltage VSENSE across the sense resistor 107 which is proportional to the output current IOUT. The voltage VSENSE is converted by the voltage to current converter 108. The voltage to current converter 108 may include a sense amplifier, for example. The output current ripple is relatively quite small and therefore a sense amplifier included in the voltage to current converter 108 may not need to be a high bandwidth amplifier. Additionally, an optional capacitor with one end connected to the node between the inductor 104 and the sense resistor 107 and the second end to ground will further reduce the switching frequency ripple in the output current flowing through the sense resistor 107. The voltage VSENSE may be converted to currents IINSNS and IOUTSNS which correspond to IOUT and may be scaled differently according to the application. The current IOUTSNS generates a voltage VIOUTSNS across resistor ROUT at a first node 112 which corresponds to the output current IOUT. Additional filtering of this voltage may suppress any switching frequency ripple. The current IINSNS generates a voltage VIINSNS across resistor RIN at a second node 111. The third switch 115 shorts the voltage at node 111 to ground during the times the first switch 102 is open and not passing current from supply Vin. The shorting of node 111 results in VIINSNS being zero volts for the duration of the time in which the input current IIN from the supply is zero amperes, thereby making VIINSNS correspond to the input current IIN.

The filter 109 may be coupled to receive the voltage VIINSNS and may average this voltage over several switching cycles and produces a voltage VIINAVGSNS which may correspond to the average input current. This additional filter 109 may also be eliminated because the control loop bandwidth may be much lower than the switching frequency.

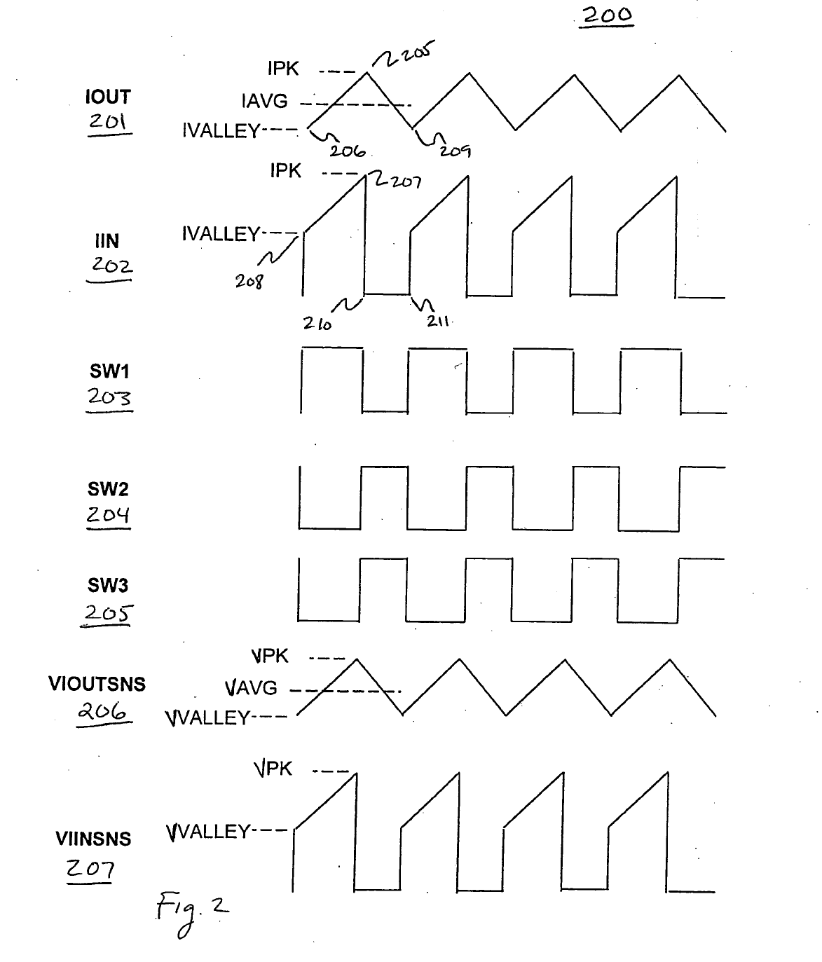

FIG. 2 illustrates the waveforms for the embodiment of FIG. 1. FIG. 2 includes IOUT 201, IIN 202, a switch control signal SW1 203, and a switch control signal SW2 204, a switch control signal SW3 205, VIOUTSNS 206, and VIINSNS 207. When SW1 is high (i.e. when the first switch 102 is closed) the second switch 103 is open and the output current IOUT 201 flowing through the inductor 104 ramps up from IVALLEY 206 to IPK 205. Similarly, when the first switch 102 is open and the second switch 103 closes, the output current IOUT 201 ramps down from IPK 205 to IVALLEY 209. Averaging the output current IOUT 201 over several switching cycles gives the average output current indicated by the line IAVG. VIOOUTSNS corresponds to the output current IOUT 201 and may be averaged to attain an average voltage VAVG corresponding to IAVG.

VIINSNS 207 is based on information about the input current IIN 202 included in the sensed output current IOUT and information regarding when the input current IIN 202 is zero. This information may be used to generate a voltage (e.g., VIINSNS), which may be used to determine the input current INN. Input current IIN 202 comprises a first portion and a second portion of a cycle of the waveform. The first portion of the cycle is substantially from IVALLEY 208 to IPK 207, and the second portion of the cycle is substantially from point 210 to point 211. When the first switch 102 is closed, the output current flows through switch 102 from the input supply, and output current 201 corresponds to the input current 202 (i.e, both currents ramp from IVALLEY to IPK). The voltage VIINSNS corresponds to the output current IOUT during the first portion of the cycle from IVALLEY 206 to IPK 205 and therefore VIINSNS corresponds to the input current IIN 202 for the first portion of the cycle. During the second portion of the cycle, the first switch 102 is opened and the second switch 103 is closed (i.e. SW2 is high), which results in a zero input current IIN 202 during the second portion of the cycle. Accordingly, the voltage VIINSNS is shorted to ground by the third switch 115 during the second portion of the cycle when the input current IIN 202 is substantially zero. Therefore VIINSNS corresponds to the input current IIN 202 for this second portion of the cycle as well. In this way, VIINSNS corresponds to the input current IIN 202. Accordingly, the input current may be determined by sensing the output current IOUT.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. For example, current sensing methods according to the present invention may include some or all of the innovative features described above. Based on the above disclosure and the following claims, other arrangements, embodiments, implementations and equivalents will be evident to those skilled in the art and may be employed without departing from the spirit and scope of the invention as defined by the claim.

What is claimed is:

1. A switching regulator comprising:
an input switch for receiving an input voltage and input current from a voltage source, the input switch receiving a switching signal, wherein the switching signal turns the input switch on and off;
an inductor having a first terminal coupled to the input switch, the inductor generating an output current; and
a converter, the converter sensing the output current and generating a signal, wherein the signal corresponds to the output current,
wherein the signal is activated and deactivated so that the signal is active when the input current flows through the input switch and the signal is deactivated when the input current does not flow through the switch.
